(19) United States
(12) Patent Application Publication
(10) Pub. No.: US 2016/0119551 A1
(43) Pub. Date: Apr. 28, 2016

(54) Optimized 360 Degree De-Warping with Virtual Cameras

(71) Applicants: Anthony L. Brown, Tinley Park, IL (US); Thomas Carnevale, Plainfield, IL (US); Patryk Szajer, Warsaw (PL)

(72) Inventors: Anthony L. Brown, Tinley Park, IL (US); Thomas Carnevale, Plainfield, IL (US); Patryk Szajer, Warsaw (PL)

(73) Assignee: SENTRY360, Plainfield, IL (US)

(21) Appl. No.: 14/801,565

(22) Filed: Jul. 16, 2015

Related U.S. Application Data
(60) Provisional application No. 62/067,121, filed on Oct. 22, 2014.

(51) Int. Cl. H04N 5/262; G06T 3/00

(52) U.S. Cl. CPC H04N 5/2628; G06T 3/0093

(57) ABSTRACT

A software suite for optimizing the de-warping of wide angle lens images includes a calibration process utilizing a calibration circle to prepare raw image data. The calibration circle is used to map the raw image data about a warped image space, which is then used to map a de-warped image space for processed image data. The processed image data is generated from the raw image data by copying color values from warped pixel coordinates of the warped image space to de-warped pixel coordinates of the de-warped image space. The processed image data is displayed as a single perspective image and a panoramic image in a click-to-position virtual mapping interface alongside the raw image data. A user can make an area of interest selection by clicking the raw image data, the single perspective image, or the panoramic image in order to change the point of focus within the single perspective image.

The current application claims a priority to the U.S. Provisional Patent application Ser. No. 62/067,121 filed on Oct. 22, 2014.

### FIELD OF THE INVENTION

The present invention relates generally to manipulating camera images. More specifically, the present invention is a software suite for de-warping wide angle lens images.

### BACKGROUND OF THE INVENTION

Presently, footage from fisheye lenses such as those used in certain types of surveillance cameras results in distorted images. De-warping is an optimized computational method for transforming those distorted wide angle images (360 by 180 degrees) into perspective corrective views. Typically a computer algorithm would compose the de-warped image by calculating the warped pixel coordinates for each de-warped pixel and copying the color values accordingly. Basic three dimensional geometry has been successfully applied for determining a function to calculate the warped pixel coordinates for each of the de-warped pixel coordinates. However, direct implementation of the function in a programming language would be inefficient and would render the solution impractical in real world applications. It is therefore an objective of the present invention to introduce an efficient implementation of de-warping that users can utilize to overcome such problems. The proposed optimization techniques for de-warping allow to use the de-warping theory in practical, real world applications and have proven to be successful. Users can thus convert distorted fisheye images into conventional flat images. Additionally, the concept of virtual cameras (VCAMs) is introduced.

### SUMMARY OF THE INVENTION

The present invention introduces an optimized computational method for transforming distorted wide angle images (360 by 180) from fish-eye lenses into perspective corrected views. The present invention is a software suite, providing a system and method for converting distorted raw image data from a wide angle camera, such as a fisheye lens, into processed image data to be displayed as a single perspective image and a panoramic image. The raw image data first goes through a calibration process and some processes for cross-platform compatibility provided through a redistributable software development kit (SDK). The calibration process utilizes a calibration circle that is aligned with the raw image data display and then used to map a warped image space. The warped image space is then utilized to calculate warped pixel coordinates for de-warped pixel coordinates in a de-warped image space. The software suite also contains processes for algorithm self-containment, resolution scaling, and central processing unit optimization. Furthermore, the software suite supports cross-compression compatibility, and provides a click-to-position virtual mapping interface used to select different virtual camera views. The software suite also has database independency, meaning the redistributable SDK requires no Structured Query Language data to function. Lastly, the software suite has parameters for the wide angle camera being both floor and ceiling mounted, so the images can be converted even from these different mounting positions with different perspective views.

### BRIEF DESCRIPTION OF THE DRAWINGS

FIG. 1 is a flowchart depicting steps for implementing the software suite for de-warping raw image data from a wide angle lens;

FIG. 2 is a flowchart thereof, further depicting steps for generating the processed image data from the raw image data;

FIG. 3 is a flowchart thereof, further depicting steps for caching warped pixel coordinates corresponding to the de-warped pixel coordinates of the single perspective image;

FIG. 4 is a flowchart thereof, further depicting steps for making an area of interest selection within the single perspective image through the click-to-position virtual mapping interface;

FIG. 5 is a flowchart thereof, further depicting steps for caching warped pixel coordinates corresponding to the de-warped pixel coordinates of the panoramic image;

FIG. 6 is a flowchart thereof, further depicting steps for making an area of interest selection within the panoramic image through the click-to-position virtual mapping interface; and

FIG. 7 is a flowchart thereof, further depicting steps for making an area of interest selection within the raw image data through the click-to-position virtual mapping interface.

FIG. 8 is a diagram depicting the warped image space and the de-warped image space for the raw image data and the processed image data respectively.

FIG. 9 is a depiction of the warped coordinate function.

FIG. 10A is a depiction of exemplary pseudo-code for de-warping the raw image data; and

FIG. 10B is a continuation of the pseudo-code in FIG. 10A.

FIG. 11 is a depiction of the interactive calibration window, wherein the calibration circle is not aligned with the raw image data.

FIG. 12 is a depiction of the interactive calibration window, wherein the calibration circle is aligned with the raw image data.

FIG. 13 is a depiction of the software suite being used to create multiple virtual cameras (VCAMs) from the raw image data.

FIG. 14 is another depiction of the software suite being used to create multiple VCAMs from the raw image data.

FIG. 15 is a depiction of the click-to-position virtual mapping interface, wherein an area of interest selection is made within the raw image data display.

FIG. 16 is a depiction of the click-to-position virtual mapping interface, wherein an area of interest selection is made by clicking within the single perspective image display.

FIG. 17 is a depiction of the click-to-position virtual mapping interface, wherein an area of interest selection is made by clicking and dragging within the single perspective image display; and

FIG. 18 is a depiction of the click-to-position virtual mapping interface thereof, wherein the focus of the single perspective image is updated to the dragged location.

FIG. 19 is a depiction of the click-to-position virtual mapping interface, wherein an area of interest selection is made within the panoramic image display.

FIG. 20 is another depiction of the click-to-position virtual mapping interface, wherein an area of interest selection is made within the panoramic display.

FIG. 21 is a depiction of the click-to-position virtual mapping interface, wherein the third Boolean parameter and the fourth Boolean parameter are false, resulting in the normal display of the single perspective image and the panoramic image respectively.

FIG. 22 is a depiction of the click-to-position virtual mapping interface, wherein the third Boolean parameter and the fourth Boolean parameter are true, resulting in the inverted display of the single perspective image and the panoramic image respectively.

### DETAIL DESCRIPTIONS OF THE INVENTION

All illustrations of the drawings are for the purpose of describing selected versions of the present invention and are not intended to limit the scope of the present invention.

The present invention is a software suite for optimizing the de-warping of wide angle lens images. The software suite provides a redistributable software development kit (SDK) that contains a de-warping algorithm for generating processed image data 3 (i.e. de-warped images) from raw image data 2 (i.e. warped images). The redistributable SDK 1 allows for the versatile implementation of the software suite in any number of networks and operating systems.

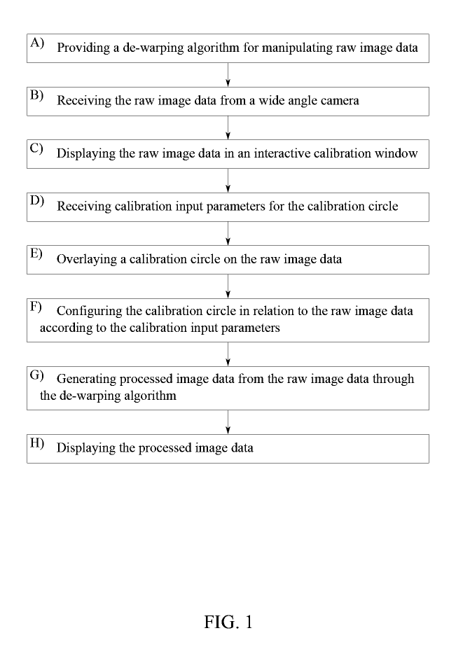

In order to properly convert the raw image data 2 into the processed image data 3, the software suite provides a calibration process. In reference to FIG. 1, the raw image view is received from a wide angle camera (e.g. a fisheye lens) and displayed through an interactive calibration window 11. The calibration process allows the de-warping algorithm to be used with any image resolution, any wide angle camera lens, and any sensor, at any alignment. The calibration process gives the de-warping algorithm an advantage for use with each wide angle camera's unique sensor and lens alignment, because the calibration process does not require the wide angle camera to have a perfectly centered fisheye image displayed on the screen.

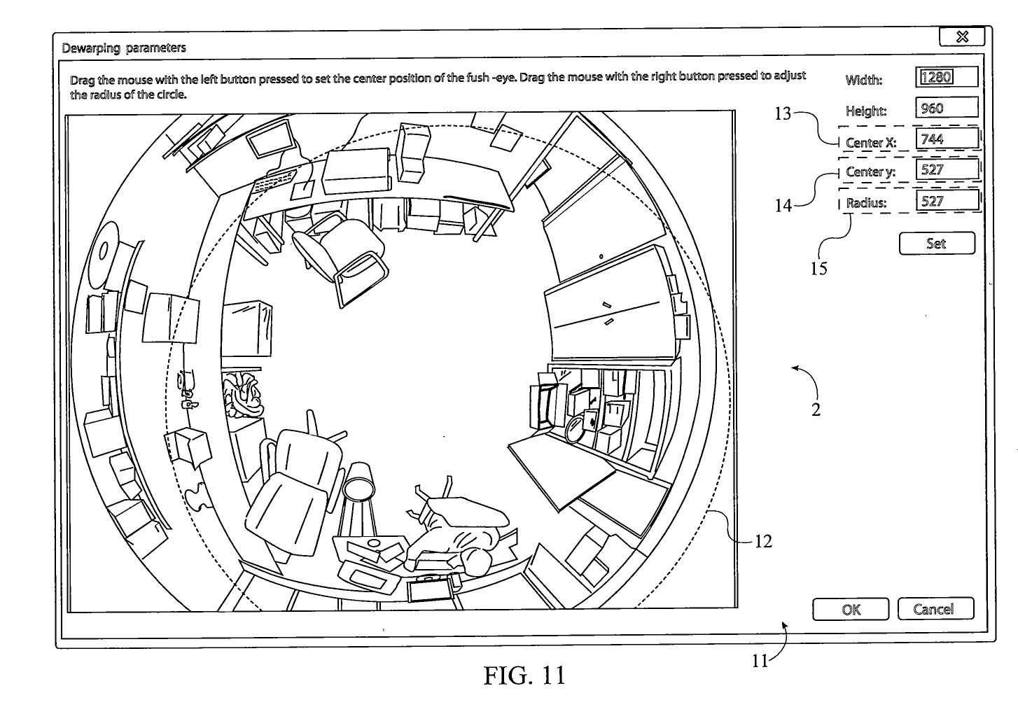

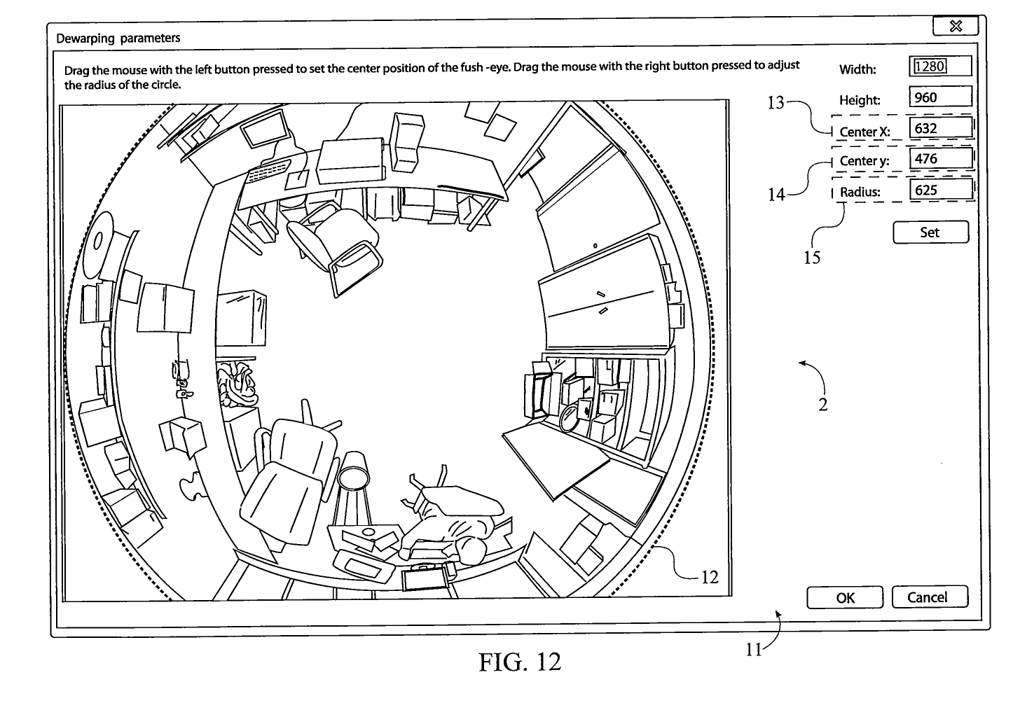

In reference to FIG. 11-12, the calibration process utilizes a calibration circle 12 that is overlaid on the raw image data 2. The calibration process is carried out by manipulating the calibration circle 12 such that the calibration circle 12 aligns exactly (or as close as possible) with the edge of the raw image data 2 as depicted in FIG. 12. The raw image data 2 being from a native fisheye image is naturally circular, hence the implementation of the calibration circle 12. Calibration input parameters are entered into the software suite through the interactive calibration window 11 by the user, wherein the calibration parameters defines the size of the raw image data 2 and both the location and size of the calibration circle 12. In reference to FIG. 1, the software suite receives the calibration input parameters and overlays the calibration circle 12 on the raw image data appropriately.

The calibration parameters includes five different parameters, two parameters for defining the size of the raw image data 2 and three parameters for defining the location and size of the calibration circle 12. The two parameters for defining the size of the raw image data 2 include a width of the raw image data 2 and a height of the raw image data 2. In the preferred embodiment of the present invention, the width of the raw image data 2 and the height of the raw image data 2 are known by the software suite through the incoming stream from the wide angle camera. It is also possible for the width of the raw image data 2 and the height of the raw image data 2 to be manually entered in other embodiments of the present invention.

The three parameters of the calibration parameters used to define the calibration circle 12 include a x-coordinate value 13, a y-coordinate value 14, and a radius value 15, as shown in FIG. 11-12. The x-coordinate value 13 defines the horizontal position of the center point of the calibration circle 12 about the interactive calibration window 11, while the y-coordinate value 14 defines the vertical position of the center point of the calibration circle 12 about the interactive calibration window 11. The radius value 15 defines the radius of the calibration circle 12.

By manipulating the x-coordinate value 13, the y-coordinate value 14, and the radius value 15 the user can align the calibration circle 12 with the raw image data 2. The x-coordinate value 13, the y-coordinate value 14, and the radius value 15 can be manipulated in two ways. The first way to adjust the x-coordinate value 13, the y-coordinate value 14, and the radius value 15 is by clicking and dragging the calibration circle 12 within the interactive calibration window 11. The user can left click and drag to reposition the calibration circle 12 (i.e. adjust the x-coordinate value 13 and the y-coordinate value 14) and right click and drag to resize the calibration circle 12 (i.e. adjust the radius value 15).

The second way to adjust the calibration parameters is by inputting each of the x-coordinate value 13, the y-coordinate value 14, and the radius value 15 into an input field. The input field for the x-coordinate value 13, the input field for the y-coordinate value 14, and the input field for the radius value 15 are displayed through the interactive calibration window 11, alongside the calibration circle 12. The user simply selects the input field for either the x-coordinate value 13, the y-coordinate value 14, or the radius value 15 and then enters the desired number. An input field for the width of the raw image data 2 and an input field for the height of the raw image data 2 are also displayed alongside the calibration circle 12.

In reference to FIG. 1, the software suite configures the calibration circle 12 in relation to the raw image data 2 according to the calibration input parameters. FIG. 12 shows the position of the calibration circle 12 after each of the calibration parameters has been set, in comparison to the initial position of the calibration circle 12 in FIG. 11. The calibration circle 12 is aligned with the edge of the raw image data 2 and the input field for each of the calibration parameters is updated accordingly. As not all cameras are configured in the same way, the calibration process allows the de-warping algorithm to be compatible with the raw image data 2 from any camera. The height, the width, the x-coordinate, the y-coordinate, and the radius value 15 are used to generate a warped image space 20 for the raw image data 2.

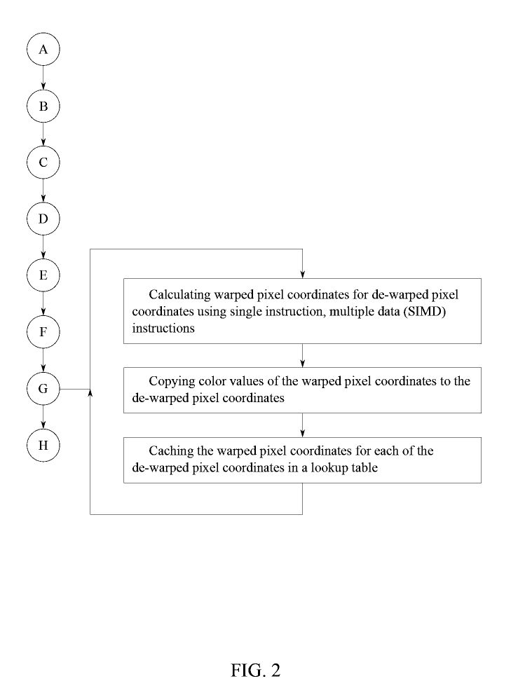

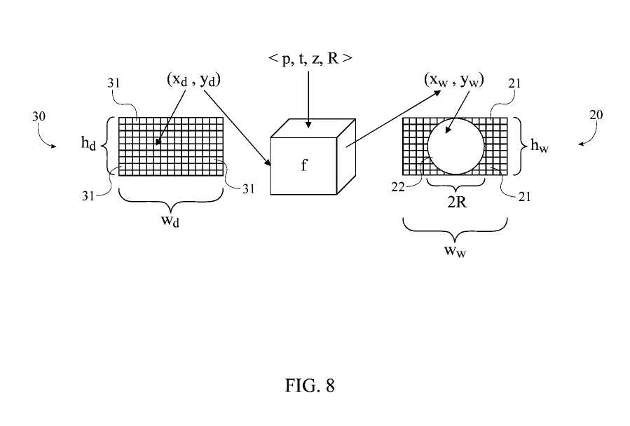

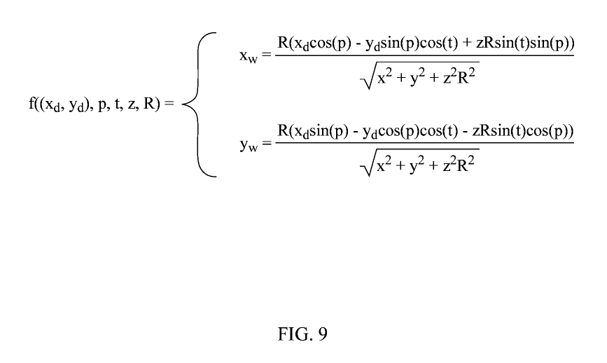

In further reference to FIG. 1, once the calibration process is completed for the raw image data 2, the software suite generates the processed image data 3 from the raw image data 2 through the de-warping algorithm. The warped image space 20 contains color values 22 for the raw image data 2 and has the height (h_{w}), the width (w_{w}), and warped pixel coordinates 21 (x_{w}, y_{w}). The warped image space 20 is utilized to generate a de-warped image space 30 for the processed image data 3, the de-warped image space 30 having a height (h_{d}), a width (h_{w}), and de-warped pixel coordinates 31 (x_{d}, y_{d}), as depicted by FIG. 8. In reference to FIG. 2, the de-warping algorithm calculates the warped pixel coordinates 21 for each of the de-warped pixel coordinates 31 in part by using single instruction, multiple data (SIMD) instructions, and then copies the color values 22 from the warped image space 20 to the de-warped image space 30 by correspondingly copying the color values 22 of each of the warped pixel coordinates 21 to the de-warped pixel coordinates 31. Basic three dimensional geometry has been successfully applied for determining a warped coordinate function (f), depicted in FIG. 9, used to calculate the warped pixel coordinates 21 for each of the de-warped pixel coordinates 31.

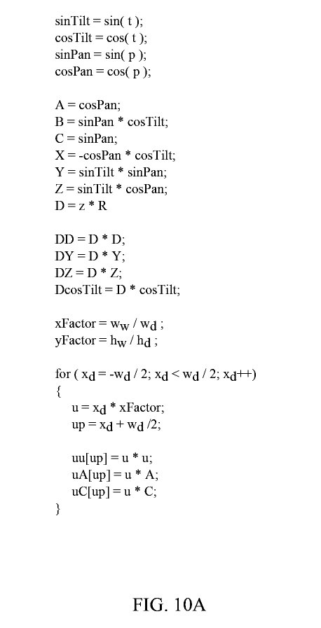

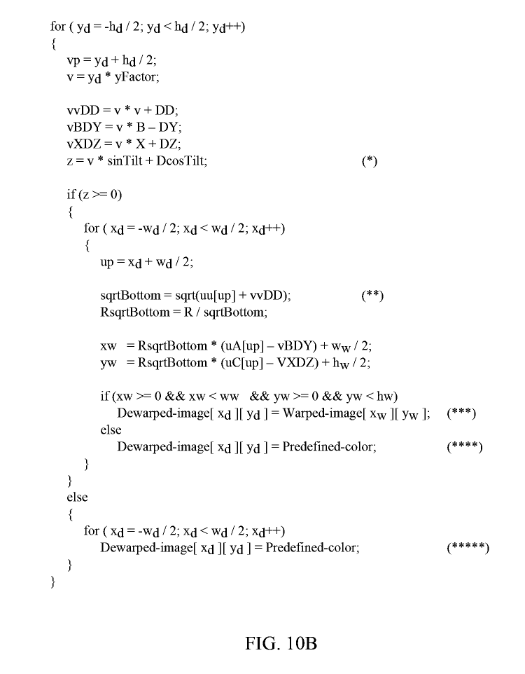

In reference to FIG. 9, the warped coordinate function utilizes the de-warped pixel coordinates 31 (x_{d}, y_{d}) as inputs. Additionally, the warped coordinate function utilizes a pan input (p), a tilt input (t), and the radius value 15 (R), which are used to calculate a z-value (z), wherein the z-value is the z-axis component of the warped point in three dimensional geometry. The output of the warped coordinate function is the warped pixel coordinates 21 (x_{w}, y_{w}), wherein each of the warped pixel coordinates 21 is a function of the de-warped pixel coordinates 31, the pan input, the tilt input, the radius value 15, and the z-value. The line labeled (*) in the pseudo-code shown in FIG. 10B provides an exemplary computation of the z-value. In computing the z-value, the sign of the z-value is determined, wherein if the z-value is non-negative, then the point (x_{w}, y_{w}, z), determined by the warped pixel coordinates 21 and the z-value, lies in the upper hemisphere, which is the only part of interest. The warped coordinate function may not be defined for certain values of the de-warped pixel coordinates 31 for certain values of the pan input, tilt input, z-value, and radius value 15; in such a case where a corresponding warped point does not exist, a pre-defined color is used for the de-warped pixel coordinates 31, as depicted by lines (****) and (*****) in FIG. 10B.

Direct implementation of the warped coordinate function in a programming language would be inefficient and would render the solution impractical in real world applications. Therefore, using a method similar to that outlined in the pseudo-code shown in FIG. 10A and FIG. 10B, the de-warping algorithm determines the warped coordinate pixels for each of the de-warped pixel coordinates 31. The only computationally expensive operation in the pseudo-code is the square root operation in the line labeled (**) as shown in FIG. 10B. The square root operation can easily be computed in one cycle using the SIMD instructions, allowing for the efficient implementation of the de-warping algorithm.

In order to further optimize the de-warping process, the concept of virtual cameras is introduced. A virtual camera (VCAM) is a perspective corrected view, wherein the pan input, the tilt input, and the z-value <p, t, z> are constant parameters.

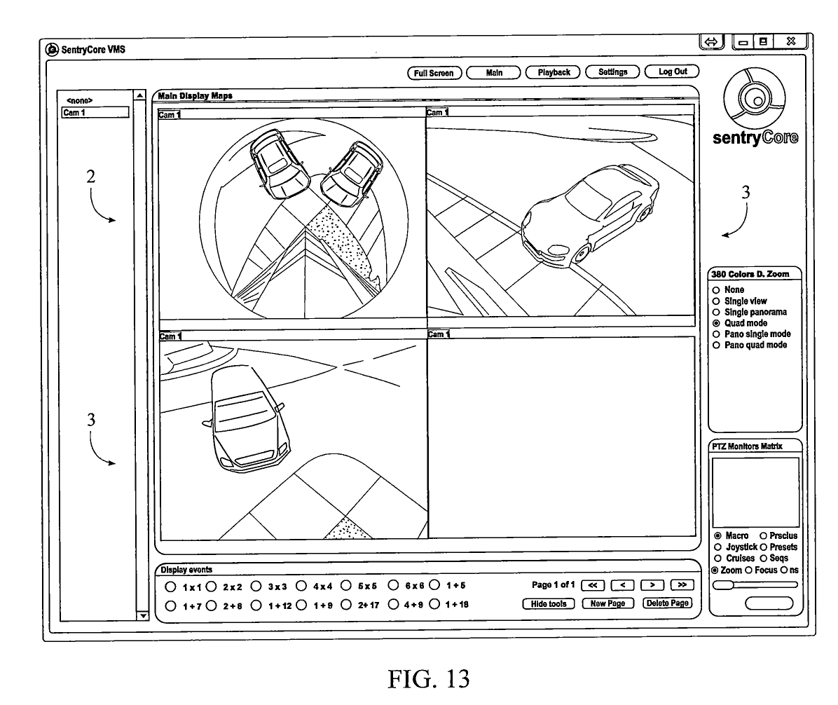

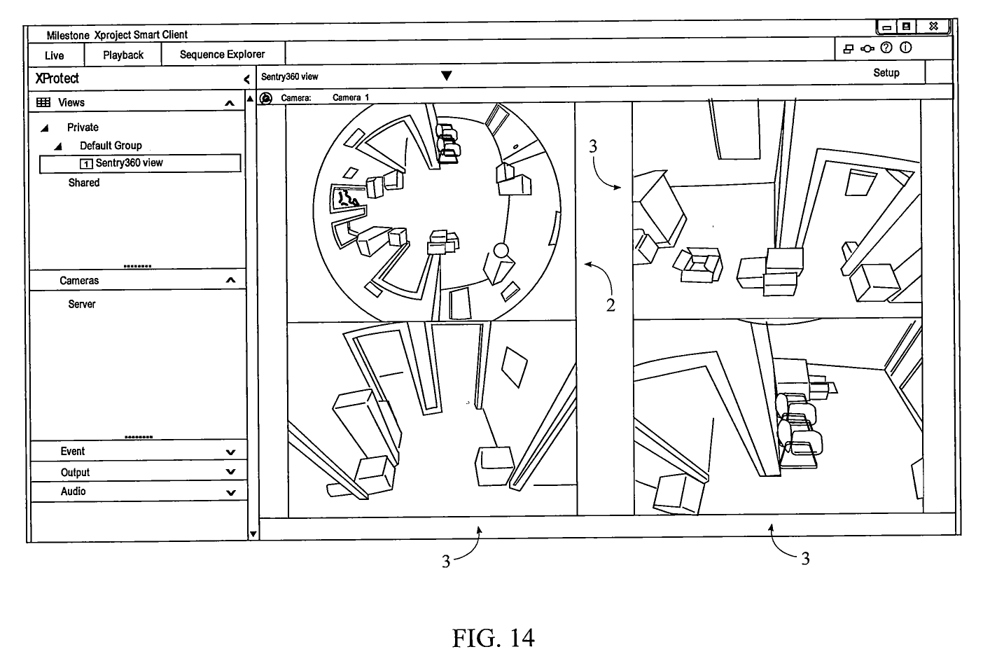

Typically, an operator display would contain four VCAMs with the parameters of: <0, π/4, z>, <π/4, π/4, z>, <π/2, π/4, z>, <3π/4, π/4, z> for a given value of z. This allows the operator to see almost all of the image in an effective way. FIG. 13-14 provide examples of the software suite being utilized to display the raw image data 2 in addition to multiple VCAMs generated from the raw image data 2. Because the pan input, the tilt input, and the z-value parameters of the VCAM are constant, the values of the warped coordinate function can be cached for the VCAM. Lines (***), (****), and (*****) of the pseudo-code in FIG. 10B exemplify the ability of the software suite to cache the warped pixel coordinates 21 of each of the de-warped pixel coordinates 31 in a lookup table through the de-warping algorithm as outlined in FIG. 2. This approach is most effective when displaying multiple consecutive images (i.e. video) from one source, as the warped pixel coordinates 21 and the de-warped pixel coordinates 31 can be easily retrieved from the lookup table for each subsequent image without re-computing the warped coordinate function.

In reference to FIG. 1, once the processed image data 3 is generated from the raw image data 2 through the de-warping algorithm, the software suite displays the processed image data 3 to the user. The processed image data 3 is displayed as both a single perspective image 32 and a panoramic image 35 in a click-to-position virtual mapping interface 16. Additionally, the raw image data 2 is displayed alongside the single perspective image 32 and the panoramic image 35 in the click-to-position virtual mapping interface 16. Through the click-to-position virtual mapping interface 16 the user can make an area of interest selection 17 by clicking on an area of either the raw image data 2, the panoramic image 35, or the single perspective image 32. The area of interest selection 17 marks a focal point on which to focus the single perspective image 32.

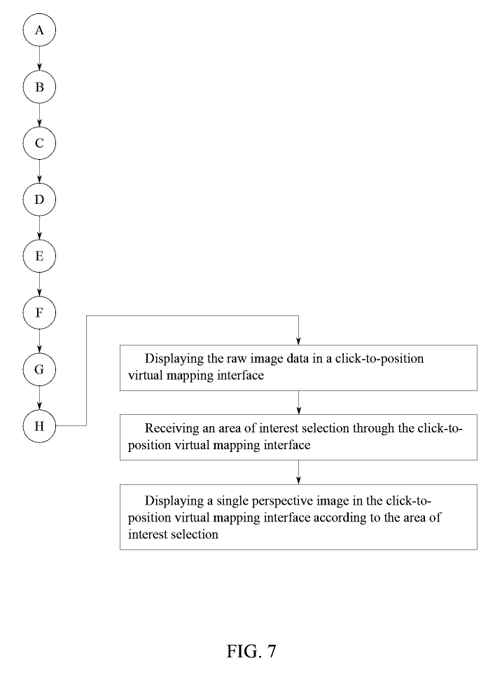

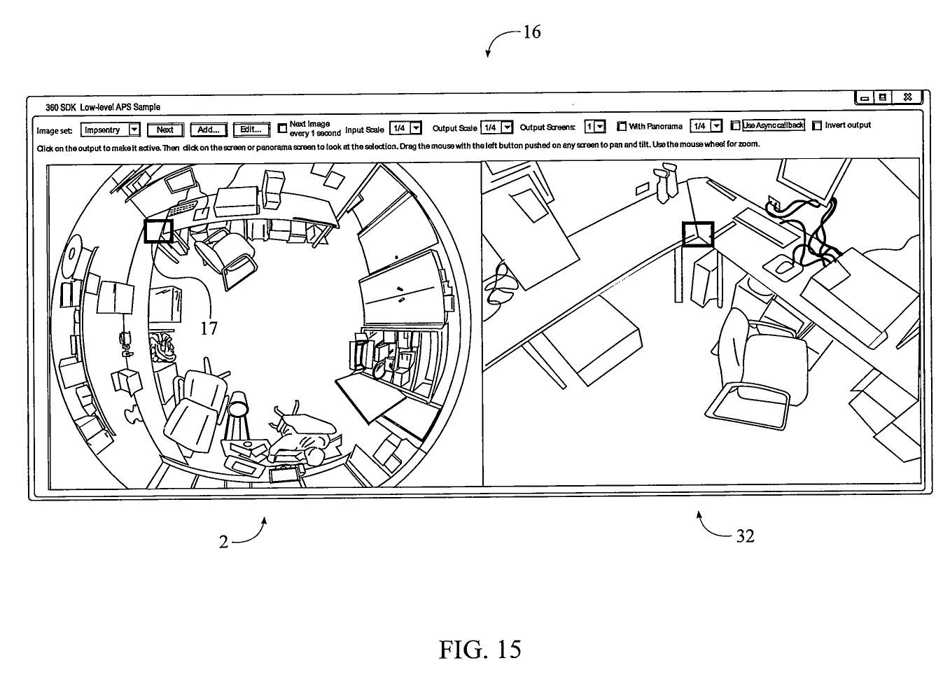

In reference to FIG. 7, to make the area of interest selection 17 using the raw image data 2, the user clicks on a location within the raw image data 2 through the click-to-position virtual mapping interface 16. The software suite receives the area of interest selection 17 as an input through the click-to-point virtual mapping interface and displays the single perspective image 32 in the click-to-point virtual mapping interface according to the area of interest selection 17. FIG. 15 illustrates the click-to-point virtual mapping interface, wherein the raw image data 2 is displayed on the left and the single perspective image 32 is displayed on the right. The area of interest selection 17 is indicated in the display of the raw image data 2 and the single perspective image 32 is focused on the area of interest selection 17 accordingly.

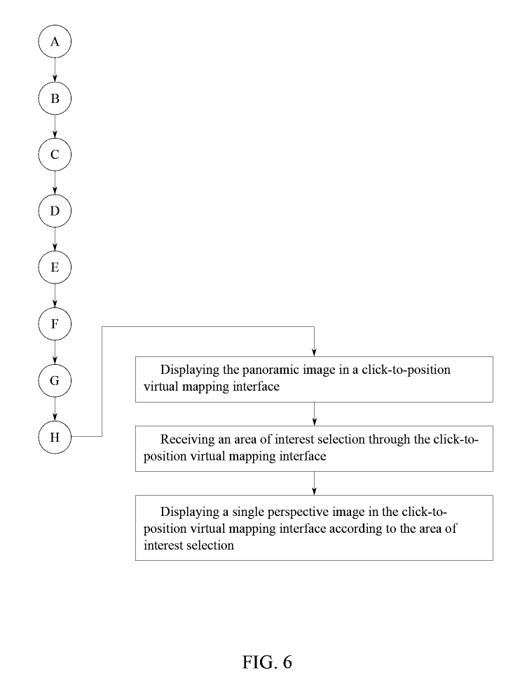

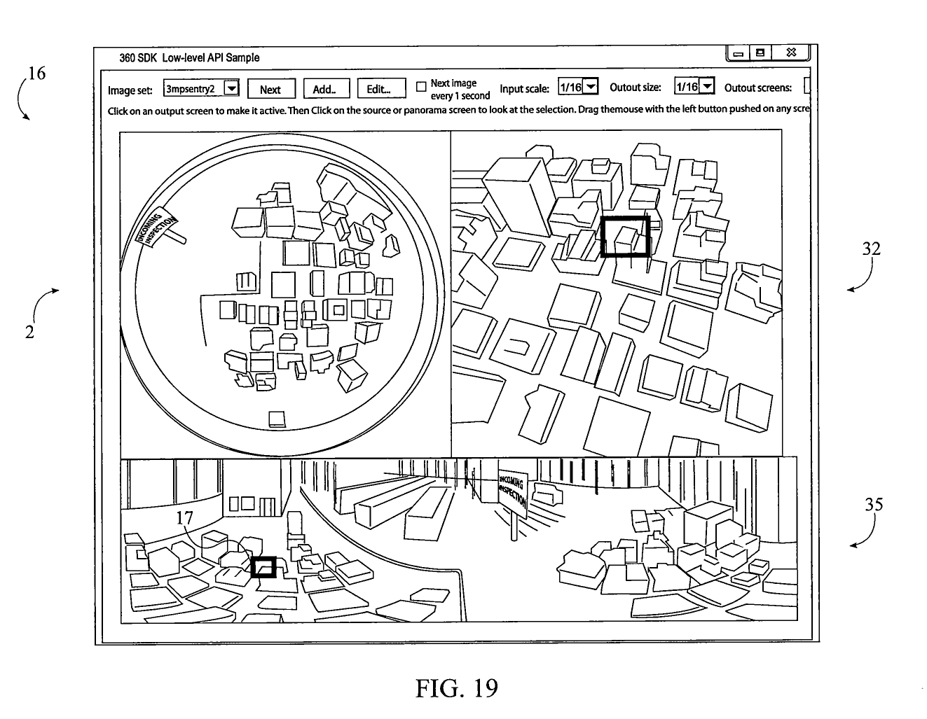

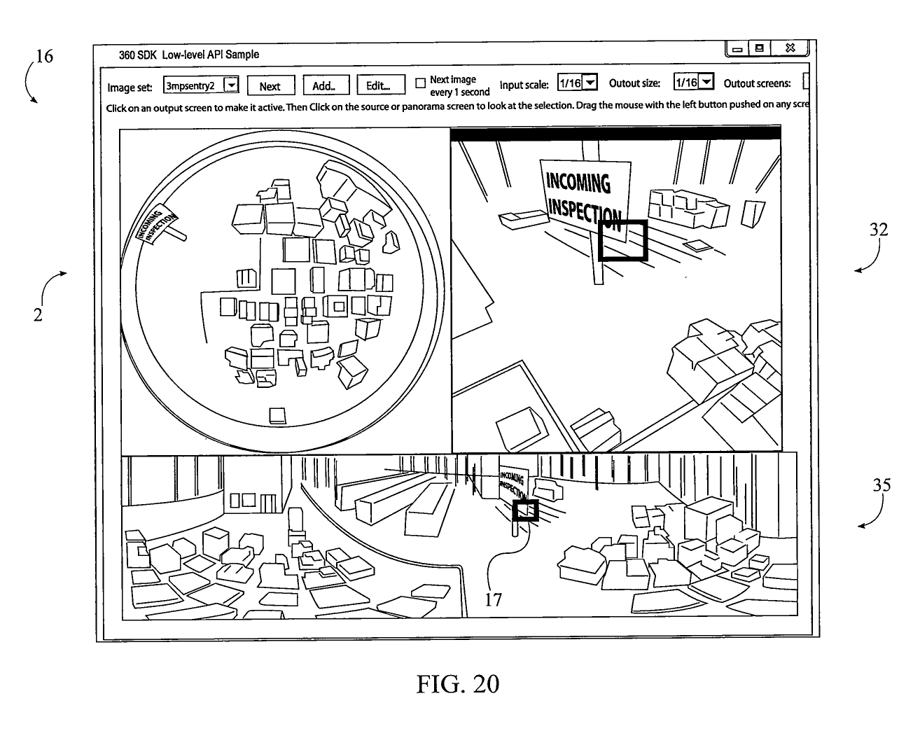

In reference to FIG. 6, to make the area of interest selection 17 using the panoramic image 35, the user clicks on a location within the panoramic image 35 through the click-to-position virtual mapping interface 16. The software suite receives the area of interest selection 17 as an input through the click-to-point virtual mapping interface and displays the single perspective image 32 in the click-to-point virtual mapping interface according to the area of interest selection 17. FIG. 19-20 illustrate the click-to-point virtual mapping interface, wherein the panoramic image 35 is displayed on the bottom and the single perspective image 32 is displayed on the right. The area of interest selection 17 is indicated in the display of the panoramic image 35 and the single perspective image 32 is focused on the area of interest selection 17 accordingly. In addition to the single perspective image 32, the panoramic image 35 may be updated such that the center of the panoramic image 35 is focused on the area of interest selection 17.

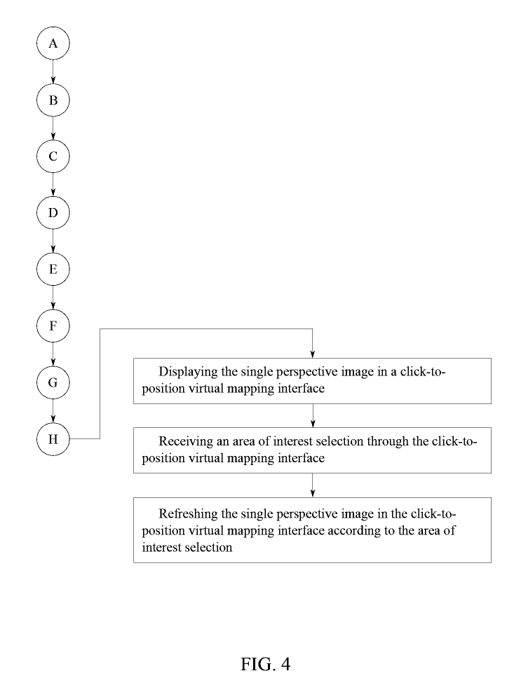

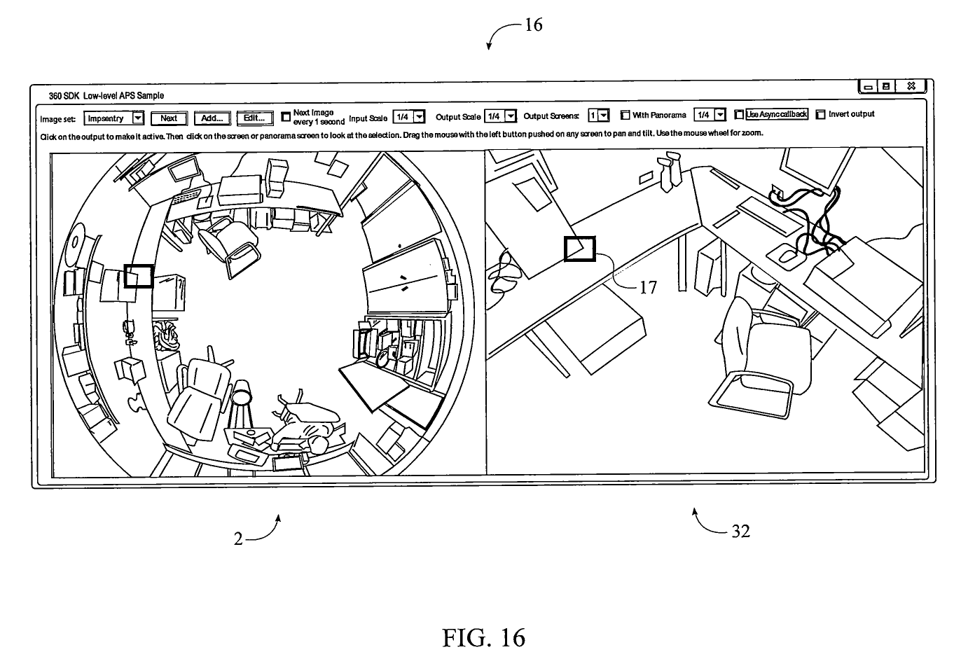

In reference to FIG. 4, to make the area of interest selection 17 using the single perspective image 32, the user clicks on a location within the single perspective image 32 through the click-to-position virtual mapping interface 16. The software suite receives the area of interest selection 17 as an input through the click-to-point virtual mapping interface and refreshes the single perspective image 32 in the click-to-point virtual mapping interface according to the area of interest selection 17. FIG. 16 illustrates the click-to-point virtual mapping interface, wherein the single perspective image 32 is displayed on the right. The area of interest selection 17 is indicated in the display of the single perspective image 32 and the single perspective image 32 will then be focused on the area of interest selection 17 accordingly.

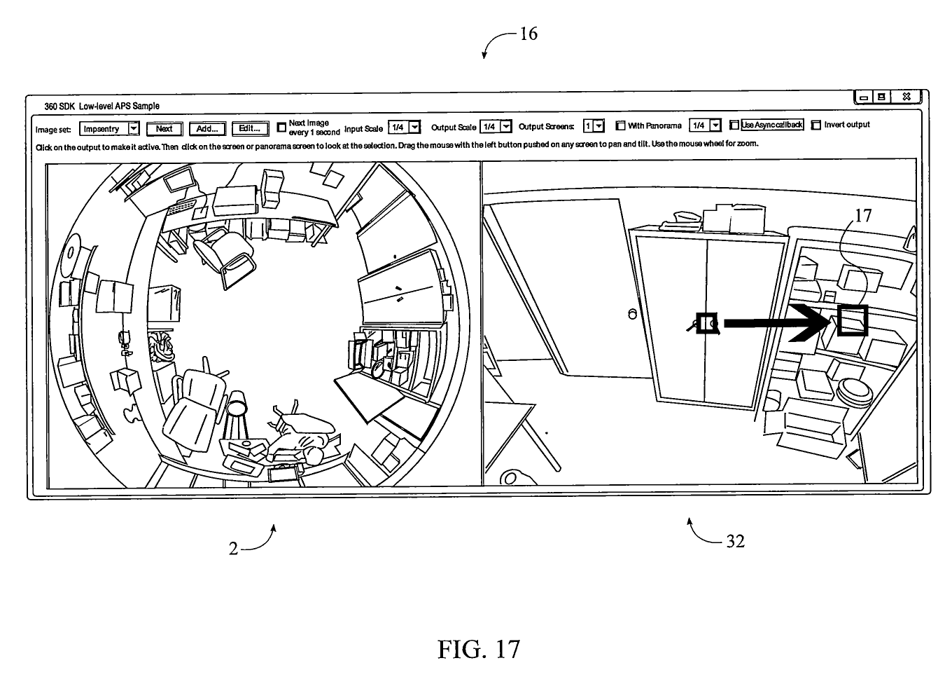

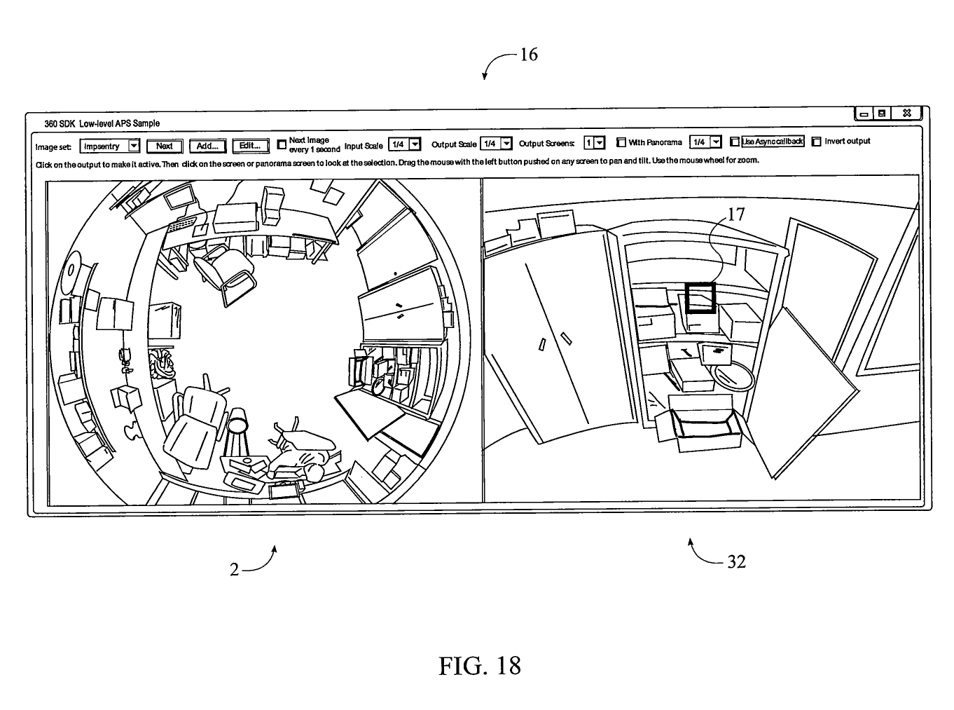

In addition to clicking within the single perspective image 32 to make the area of interest selection 17, the user can also click and drag within the single perspective image 32. FIG. 17 illustrates the initial click, followed by a dragging motion in order to make the area of interest selection 17 within the single perspective image 32. Dragging the mouse to the right pans the view to the right by shifting the single perspective image 32 to the left, wherein the pan input and the tilt input are adjusted for the single perspective image 32. FIG. 18 then shows the single perspective image 32 being refreshed to reflect the area of interest selection 17.

The click-to-position virtual mapping interface 16 can be used to set up multiple VCAMs from the raw image data 2, wherein the single perspective image 32 is displayed for each of the VCAMs, as depicted in FIG. 13-14. The user can also utilize the click-to-position virtual mapping interface 16 to adjust the zoom for the single perspective image 32.

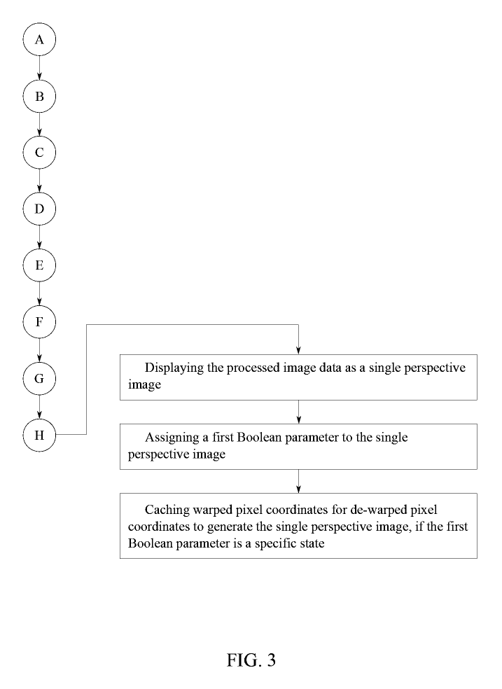

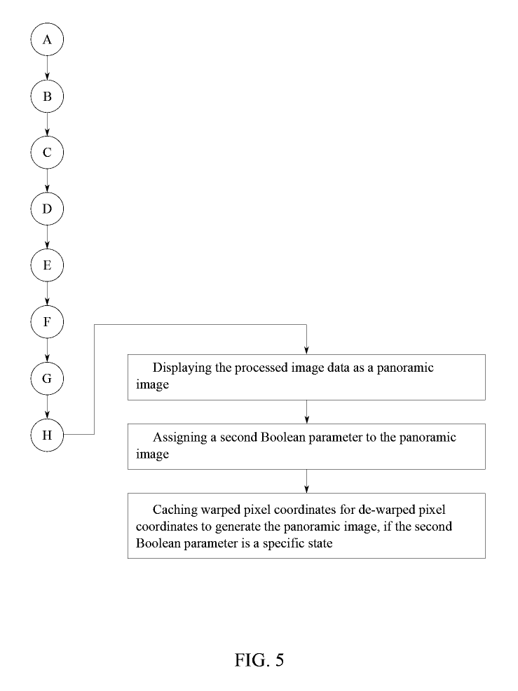

In reference to FIG. 3 and FIG. 5, in order to optimize the display of the single perspective image 32 and the panoramic image 35 during a video stream from the wide angle camera, the redistributable SDK 1 assigns a first Boolean parameter 33 to the single perspective image 32 and a second Boolean parameter 36 to the panoramic image 35. The first Boolean parameter 33 and the second Boolean parameter 36 determine whether or not the warped pixel coordinates 21 for each of the de-warped pixel coordinates 31 of the single perspective image 32 and the panoramic image 35, respectively, are cached. A Boolean expression is used to determine a specific state of the first Boolean parameter 33 and the second Boolean parameter 36; the specific state being either true or false. The Boolean expression is used to evaluate whether or not the pan input, the tilt input, or the zoom have been adjusted for the display of the processed image data 3 and in turn determine the specific state for the first Boolean parameter 33 and the second Boolean parameter 36.

If the pan input, the tilt input, or the zoom is adjusted, then the Boolean expression produces the first Boolean parameter 33 and the second Boolean parameter 36 in the specific state being true. In reference to FIG. 3, when the specific state of the first Boolean parameter 33 is true the warped pixel coordinates 21 for each of the de-warped pixel coordinates 31 is cached in the lookup table for the single perspective image 32. Similarly and in reference to FIG. 5, when the specific state of the second Boolean parameter 36 is true the warped pixel coordinates 21 for each of the de-warped pixel coordinates 31 is cached in the lookup table for the panoramic image 35. In this way, the amount of calculations and re-drawing that needs to be done is reduced for the video stream once the new parameters for the pan input, the tilt input, and the zoom are set.

If the pan input, the tilt input, and the zoom are not adjusted, then the Boolean expression produces the first Boolean parameter 33 and the second Boolean parameter 36 in the specific state being false. When the specific state of the first Boolean parameter 33 is false the lookup table for the single perspective image 32 is used to retrieve the warped pixel coordinates 21 for each of the de-warped pixel coordinates 31 for the single perspective image 32. Similarly, when the specific state of the second Boolean parameter 36 is false the lookup table for the panoramic image 35 is used to retrieve the warped pixel coordinates 21 for each of the de-warped pixel coordinates 31 for the panoramic image 35. In this way, the amount of calculations and re-drawing that needs to be done is reduced for the video stream as the parameters for the pan input, the tilt input, and the zoom have not changed.

The pan input, the tilt input, and the zoom can also be used in combination with a traditional optical pan-tilt-zoom (PTZ) camera, in which the PTZ camera repositions to focus on new coordinates based on the pan input, the tilt input, and the zoom. To use the PTZ camera, the wide angle camera and the PTZ camera are installed in close proximity to one another. The coordinate information for where to focus the PTZ camera is retrieved from the de-warping algorithm, wherein the PTZ camera is repositioned to focus on the coordinates corresponding to the area of interest selection 17 made through the single perspective image 32 or the panoramic image 35.

The de-warping algorithm can be configured for the wide angle camera being either pointed vertically downward or pointed vertically upward. This allows the wide angle camera being configured for vertically downward placement to also be used for vertically upward placement. The redistributable SDK 1 specifies two parameters related to displaying the output in an inverted state, both being Boolean variables; more specifically, a third Boolean parameter 34 and a fourth Boolean parameter 37. The third Boolean variable defines whether the output image should be vertically inverted for floor camera placement, while the fourth Boolean variable defines whether the panoramic image 35 should be vertically inverted for floor camera placement.

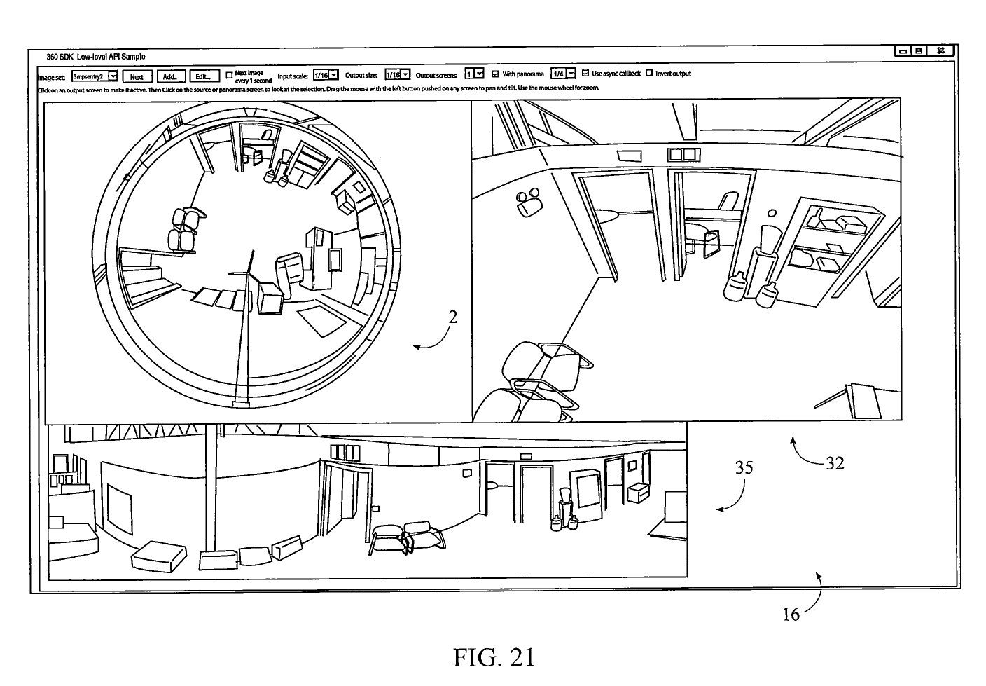

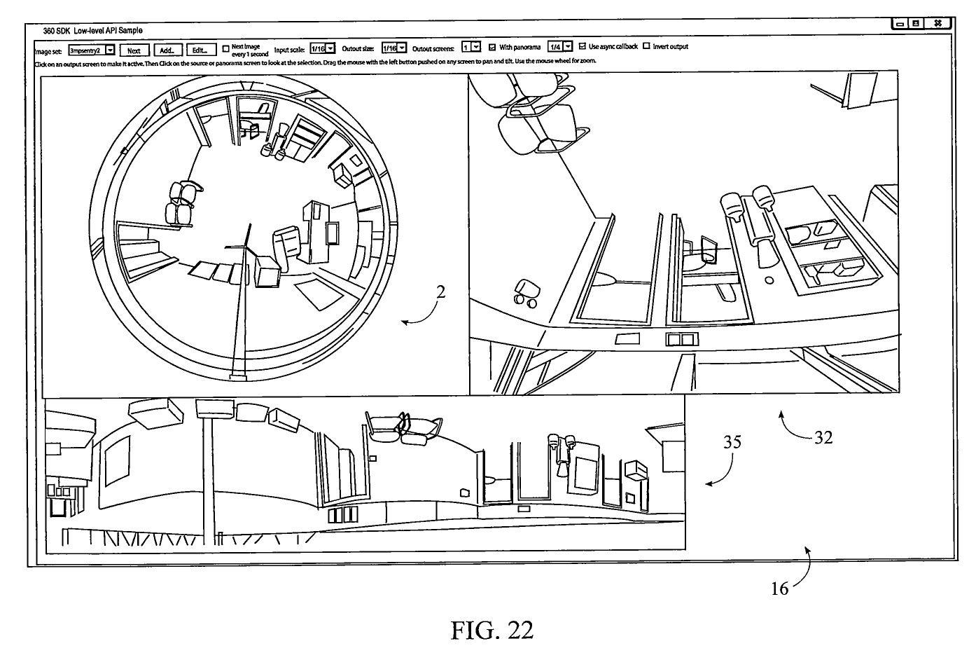

The third Boolean variable and the fourth Boolean variable are false for a standard ceiling application and true for an inverted floor application. When the third Boolean parameter 34 is true, the height and width information for the single perspective image 32 is flipped/mirrored to apply the image inversion. More specifically, each of the de-warped pixel coordinates 31 within the de-warped image space 30 is flipped/mirrored for the single perspective image 32. Similar to the third Boolean parameter 34, when the fourth Boolean parameter 37 is true, the height and width information for the panoramic image 35 is flipped/mirrored to apply the image inversion. More specifically, each of the de-warped pixel coordinates 31 within the de-warped image space 30 is flipped/mirrored for the panoramic image 35. FIG. 21 shows an example wherein the third Boolean parameter and the fourth Boolean parameter are false, while FIG. 22 shows an example wherein the third Boolean parameter and the fourth Boolean parameter are true (note: in both FIG. 21 and FIG. 22 the camera is pointed vertically downward).

The redistributable SDK 1 has been designed to give maximum possible flexibility and performance for video management system developers. The redistributable SDK 1 provides means for direct input of the raw image data 2, setting de-warping and image parameters, and the direct output of the processed image data 3. In the invention's preferred embodiment, the contents of the redistributable SDK 1 include a plurality of folders, with a summary next to each folder name. In other embodiments, the names of the folders and interior files may be different, as well as the number of folders. The following describes the plurality of folders in the preferred embodiment:

/bin—Binary file(s). This folder contains the necessary binary files for integration;

/binsamples—Sample applications. This folder contains standalone sample applications, such as 360APLNET.Sample.exe, showing an application used in a .NET development environment;

/doc—Documentation. This includes the application programming interface (API) file in portable document format (PDF), giving an overview of the redistributable SDK 1 and API, requirements of the redistributable SDK 1 to integrate into software, contents of the redistributable SDK 1 (file/folder structure), interface definitions of all classes contained in the necessary header files, and additional information related to using the API and included files;

/include—Header files required for the application to use the de-warping API;

/lib—Library files required for integration of the de-warping algorithm; and

/src—Source code samples. This folder contains source code for several example low-level projects using the de-warping API.

The redistributable SDK 1 is directly integrated into an external video management software (VMS) application through the use of a developed third party plugin. The redistributable SDK 1 allows for the cross-platform compatibility of the de-warping algorithm with different operating systems. The redistributable SDK 1 is compatible with multiple operating systems for both fixed computing devices and mobile devices, therefore the de-warping algorithm can be integrated into the software of any platform. The containment of the de-warping algorithm in the redistributable SDK 1 makes the de-warping algorithm dynamic in the sense that the de-warping algorithm can be integrated into any third party software using protocols such as .NET, C, C++, Java, etc.

The redistributable SDK 1 is compatible with the raw image data 2 being of any resolution, pixel format, and color space and allows for the scaling of the raw image data 2 to any resolution. The following image processor parameters are used for the scaling of the raw image data 2: a first value for the width of the raw image data 2, a second value for the height of the raw image data 2, a third value for the number of input image stride bytes, a fourth value for the bits per pixel for the raw image data 2, the x-coordinate value 13 and the y-coordinate value 14 defining the center point, and the radius value 15. The third value for the input image stride bytes is the width of the raw image data 2 times the bytes per pixel aligned to a boundary. Each of the image processor parameters is displayed in a input field, wherein the user can adjust the value within the input field. The redistributable SDK 1 then utilizes the image processor parameters to appropriately scale the raw image data 2 using conventional tasks.

In addition to being compatible with the raw data image having any resolution size, the redistributable SDK 1 is also compatible with any mode of compression. The nature of the de-warping algorithm to copy the color values 22 from the warped pixel coordinates 21 to the de-warped pixel coordinates 31 allows the de-warping algorithm to be utilized with any type of compressed video format. Examples of compatible compression modes include but are not limited to the following: H.264: main, baseline, and high profile, H.265; High Efficiency Video Coding (HEVC), Motion Joint Photographic Experts Group (MJPEG), Moving Picture Experts Group (MPEG) 4, and Scalable Video Coding (SVC).

The redistributable SDK 1 is database independent, meaning no Structured Query Language (SQL) data, SQL databases, or texture mapping are needed to work. Many VMS applications require the use of a database, however, the present invention does not require a database to integrate the de-warping algorithm into third party software. The database independency feature is carried out by utilizing parameters in a standard code; the standard code being unremarkable. The parameters needed do not require a database to be populated and can be obtained by other means. For example, the parameters such as the x-coordinate value 13, the y-coordinate value 14, and the radius value 15 are obtained through the calibration process. The parameters can be stored within the software, a text file, or some other storage means, but do not have to be written to a database.

Although the invention has been explained in relation to its preferred embodiment, it is to be understood that many other possible modifications and variations can be made without departing from the spirit and scope of the invention as hereinafter claimed.

What is claimed is:

1. A method for de-warping images by executing computer-executable instructions stored on a non-transitory computer-readable medium, the method comprises the steps of:
providing a de-warping algorithm for manipulating raw image data;
receiving the raw image data from a wide angle camera;
displaying the raw image data in an interactive calibration window;
overlaying a calibration circle on the raw image data;
receiving calibration input parameters for the calibration circle;
configuring the calibration circle in relation to the raw image data according to the calibration input parameters;
generating processed image data from the raw image data through the de-warping algorithm; and
displaying the processed image data.

2. The method for de-warping images by executing computer-executable instruction stored on a non-transitory computer-readable medium, the method as claimed in claim 1, wherein the calibration input parameters includes a x-coordinate value, a y-coordinate value, and a radius value.

3. The method for de-warping images by executing computer-executable instructions stored on a non-transitory computer-readable medium, the method as claimed in claim 2, wherein the x-coordinate value, the y-coordinate value, and the radius value are adjusted by clicking and dragging the calibration circle.

4. The method for de-warping images by executing computer-executable instructions stored on a non-transitory computer-readable medium, the method as claimed in claim 2, wherein the calibration input parameters are adjusted by inputting each of the x-coordinate value, the y-coordinate value, and the radius value into an input field.

5. The method for de-warping images by executing computer-executable instructions stored on a non-transitory computer-readable medium, the method as claimed in claim 1, wherein the de-warping algorithm is contained in a redistributable software development kit (SDK).

6. The method for de-warping images by executing computer-executable instructions stored on a non-transitory computer-readable medium, the method as claimed in claim 5, wherein the redistributable SDK is database independent.

7. The method for de-warping images by executing computer-executable instructions stored on a non-transitory computer-readable medium, the method as claimed in claim 1 further comprises the steps of:
displaying the processed image data as a single perspective image.

8. The method for de-warping images by executing computer-executable instructions stored on a non-transitory computer-readable medium, the method as claimed in claim 7 further comprises the steps of:
assigning a first Boolean parameter to the single perspective image; and
caching warped pixel coordinates for de-warped pixel coordinates to generate the single perspective image,
if the first Boolean parameter is a specific state.

9. The method for de-warping images by executing computer-executable instructions stored on a non-transitory computer-readable medium, the method as claimed in claim 7 further comprises the steps of:
displaying the single perspective image in a click-to-position virtual mapping interface;
receiving an area of interest selection through the click-to-position virtual mapping interface; and
refreshing the single perspective image in the click-to-position virtual mapping interface according to the area of interest selection.

10. The method for de-warping images by executing computer-executable instructions stored on a non-transitory computer-readable medium, the method as claimed in claim 1 further comprises the steps of:
displaying the processed image data as a panoramic image.

11. The method for de-warping images by executing computer-executable instructions stored on a non-transitory computer-readable medium, the method as claimed in claim 10 further comprises the steps of:
assigning a second Boolean parameter to the panoramic image; and
caching warped pixel coordinates for de-warped pixel coordinates to generate the panoramic image,
if the second Boolean parameter is a specific state.

12. The method for de-warping images by executing computer-executable instructions stored on a non-transitory computer-readable medium, the method as claimed in claim 10 further comprises the steps of:
displaying the panoramic image in a click-to-position virtual mapping interface;
receiving an area of interest selection through the click-to-position virtual mapping interface; and
displaying a single perspective image in the click-to-position virtual mapping interface according to the area of interest selection.

13. The method for de-warping images by executing computer-executable instructions stored on a non-transitory computer-readable medium, the method as claimed in claim 1 further comprises the steps of:
displaying the raw image data in a click-to-position virtual mapping interface;
receiving an area of interest selection through the click-to-position virtual mapping interface; and
displaying a single perspective image in the click-to-position virtual mapping interface according to the area of interest selection.

14. The method for de-warping images by executing computer-executable instructions stored on a non-transitory computer-readable medium, the method as claimed in claim 1 further comprises the steps of:
calculating warped pixel coordinates for de-warped pixel coordinates using single instruction, multiple data (SIMD) instructions; and
copying color values of the warped pixel coordinates to the de-warped pixel coordinates.

15. The method for de-warping images by executing computer-executable instructions stored on a non-transitory computer-readable medium, the method as claimed in claim 14 further comprises the steps of:
caching the warped pixel coordinates for each of the de-warped pixel coordinates in a lookup table.

16. A method for de-warping images by executing computer-executable instructions stored on a non-transitory computer-readable medium, the method comprises the steps of:
providing a de-warping algorithm for manipulating raw image data, wherein the de-warping algorithm is contained in a redistributable software development kit (SDK);
receiving the raw image data from a wide angle camera;
displaying the raw image data in an interactive calibration window;
overlaying a calibration circle on the raw image data;
receiving calibration input parameters for the calibration circle, wherein the calibration input parameters includes a x-coordinate value, a y-coordinate value, and a radius value;
configuring the calibration circle in relation to the raw image data according to the calibration input parameters;
generating processed image data from the raw image data through the de-warping algorithm;
calculating warped pixel coordinates for de-warped pixel coordinates using single instruction, multiple data (SIMD) instructions;
copying color values of the warped pixel coordinates to the de-warped pixel coordinates;
displaying the processed image data as a single perspective image and a panoramic image in a click-to-position virtual mapping interface;
displaying the raw image data in the click-to-position virtual mapping interface;
assigning a first Boolean parameter to the single perspective image;
caching the warped pixel coordinates for the de-warped pixel coordinates to generate the single perspective image,
if the first Boolean parameter is a specific state;
assigning a second Boolean parameter to the panoramic image;
caching the warped pixel coordinates for the de-warped pixel coordinates to generate the panoramic image,
if the second Boolean parameter is a specific state;
receiving an area of interest selection through the click-to-position virtual mapping interface; and
refreshing the single perspective image in the click-to-position virtual mapping interface according to the area of interest selection.

17. The method for de-warping images by executing computer-executable instructions stored on a non-transitory computer-readable medium, the method as claimed in claim 16, wherein the x-coordinate value, the y-coordinate value, and the radius value are adjusted by clicking and dragging the calibration circle.

18. The method for de-warping images by executing computer-executable instructions stored on a non-transitory computer-readable medium, the method as claimed in claim 16, wherein the calibration input parameters are adjusted by inputting each of the x-coordinate value, the y-coordinate value, and the radius value into an input field.

19. The method for de-warping images by executing computer-executable instructions stored on a non-transitory computer-readable medium, the method as claimed in claim 16, wherein the redistributable SDK is database independent.

20. The method for de-warping images by executing computer-executable instructions stored on a non-transitory computer-readable medium, the method as claimed in claim 16 further comprises the steps of:
caching the warped pixel coordinates for each of the de-warped pixel coordinates in a lookup table.
